(19) United States
(12) Patent Application Publication
(10) Pub. No.: US 2016/0314510 A1
(43) Pub. Date: Oct. 27, 2016

(54) Application for Searching External Sales Websites and Notifying the User of the Best Available Offer

(71) Applicant: Noel Brown, Brooklyn, NY (US)

(72) Inventor: Noel Brown, Brooklyn, NY (US)

(21) Appl. No.: 14/693,618

(22) Filed: Apr. 22, 2015

(51) Int. Cl. G06Q 30/06; H04L 12/58; H04W 4/14; G06F 17/30; G06Q 50/00

(52) U.S. Cl. CPC G06Q 30/0605; G06F 17/30864; G06Q 30/0625; G06Q 50/01; H04W 4/14; H04L 51/32

(57) ABSTRACT

A method of managing listings for products and services from external sales websites utilizes a user account, a display threshold, and a best match threshold. A plurality of buyable entities is retrieved from a plurality of external sales websites in order to provide the user account with the preferred buyable entity. In doing so, a search query is initially received from the user account and the relevant results from the plurality of buyable entities are produced accordingly. A similarity factor is used to determine if the results exceed the display threshold and the best match threshold. The results are sorted and displayed according to the similarity factor. If the preferred buyable entity is not available at first, the user account is later notified as soon as the preferred buyable entity is confirmed to be available. A preferred contact method is used in the notification process.

### FIELD OF THE INVENTION

The present invention relates generally to online searching. More specifically, the present invention is an application that customizes search results and notifies the user regarding the relevant search results.

### BACKGROUND OF THE INVENTION

The advancements in technology have led to many products and services being marketed online. Online marketing has a series of advantages. As an example, online marketing has eliminated the need to physically go to a location in order to purchase a product. Additionally, online sales also allow the user to complete a purchase within a short period of time. However, online purchasing and searching has a series of disadvantages too.

A major disadvantage with the existing online search tools is the need to reenter data for each search. More specifically, if the user searches for a certain product or service, the search queries used during the search needs to be reentered in the next search. The need to frequently reenter search queries and search related information can be a time consuming and stressful maneuver. The need to reenter search queries is especially troublesome when the user utilized different computer interfaces to conduct a search.

Another disadvantage of online searching and marketing is the excess of irrelevant information. Poor search queries or the excess of a certain item can lead to the user failing to see the desired result. As an example, if the user searches for a frequently bought item, a large number of results may be displayed. Resultantly, the user may have difficulties in finding the desired product or service. Another reason the desired result is not found is due to the unavailability of the product. Since a large number of users utilize online sales websites, frequently bought items are available only for a limited time. In order to ensure that a desired item is available, the user needs to frequently visit the specific website which can be a time consuming procedure and frustrating. Therefore, the need for an effective notification system which has the ability to notify the user regarding the availability of the desired product or service is clearly evident.

The objective of the present invention is to address the aforementioned issues. More specifically, the present invention introduces an application which searches for the most relevant results and notifies the user regarding the search results instantly. Since the user is immediately notified, it is guaranteed that the user is always allowed to view the preferred search result. Furthermore, the present invention eliminates the tedious process of reentering search data by managing the previously utilized search queries to produce relevant results for the specific user account. By utilizing the present invention, the user can search and also purchase a product or service through a common platform. Therefore, the need to visit multiple sales websites to search for a desired product or service is eliminated.

### BRIEF DESCRIPTION OF THE DRAWINGS

FIG. 1A is a flowchart illustrating the general overall process of the present invention; and

FIG. 1B is a flowchart thereof, further illustrating the general overall process of the present invention.

FIG. 2 is a flowchart illustrating the process of providing contact information.

FIG. 3 is a flowchart illustrating the process of receiving a random generation request.

FIG. 4 is a flowchart illustrating the process of storing search queries for a subsequent iteration.

### DETAIL DESCRIPTIONS OF THE INVENTION

All illustrations of the drawings are for the purpose of describing selected versions of the present invention and are not intended to limit the scope of the present invention.

The present invention introduces an application for managing online listings for products and services from external websites. More specifically, the present invention limits the irrelevant results and displays the most relevant results such that the user can select a desired result effectively. Additionally, the present invention contains a notification process which alerts the user of the desired product or service. The notification process guarantees that the user is notified as soon as the desired product or service is available. Therefore, the user can proceed to purchase the desired product or service as soon as the product or service is available.

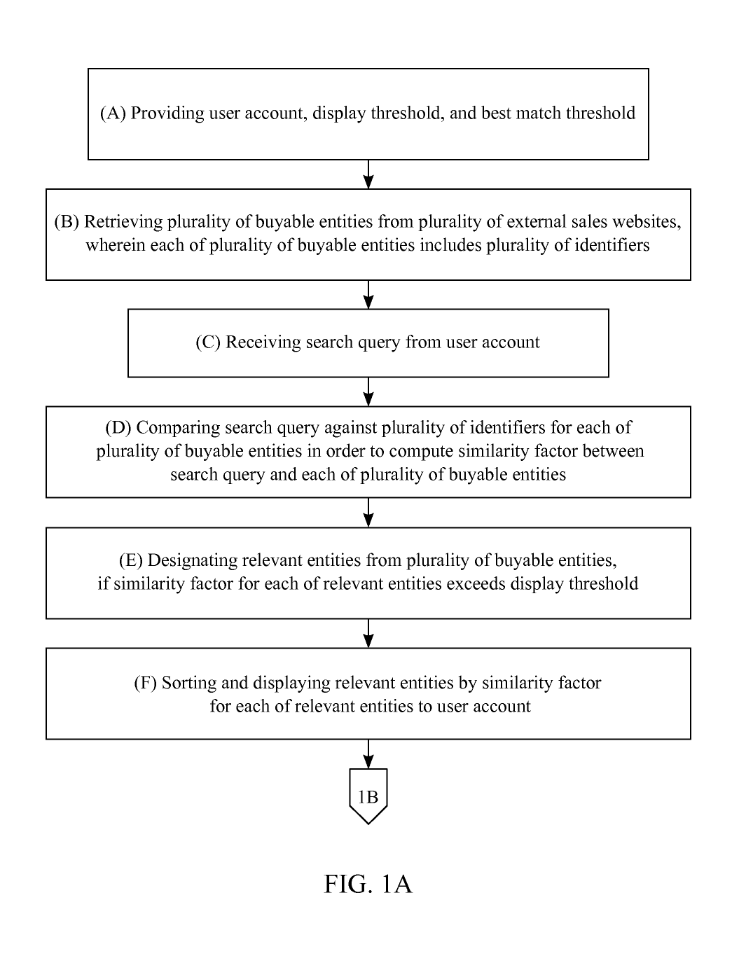

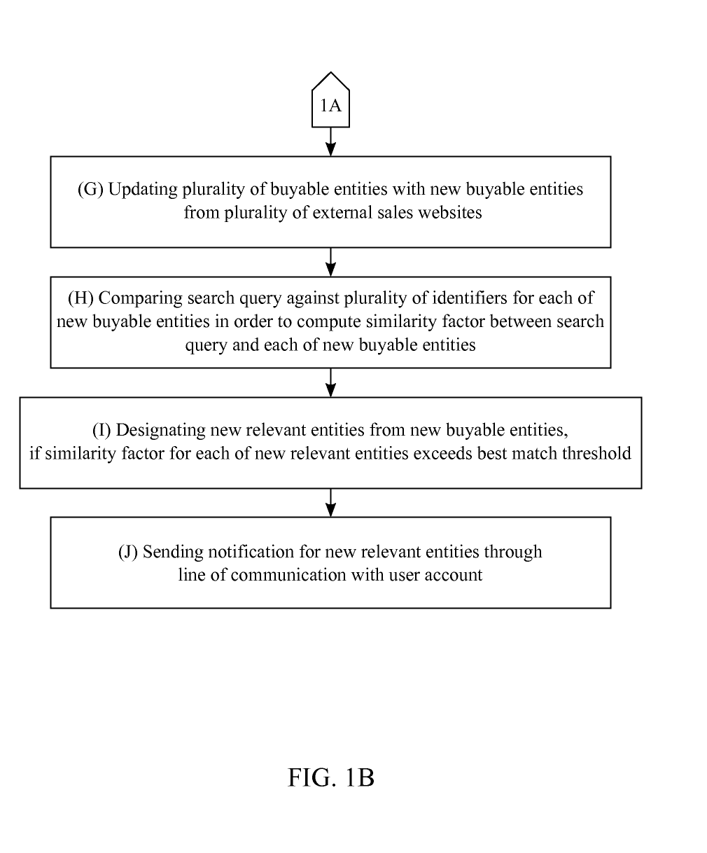

FIG. 1A and FIG. 1B are flowcharts illustrating the general overall process of the present invention. The present invention provides a user account which is used to control the present invention. On the other hand, the present invention renders services to the user account based on a display threshold and a best match threshold. In order to serve the user account, the present invention retrieves a plurality of buyable entities from a plurality of external sales websites. Moreover, each of the plurality of buyable entities includes a plurality of identifiers. The plurality of identifiers is utilized to differentiate one buyable entity of the plurality of buyable entities from another buyable entity from the plurality of buyable entities. When the user account searches for a product or service from the plurality of buyable entities, the present invention receives a search query from the user account. In order to display the most relevant results to the user account, the present invention compares the search query against the plurality of identifiers for each of the plurality of buyable entities. When the comparison is completed, a similarity factor between the search query and each of the plurality of buyable entities is computed. The similarity factor eliminates the possibility of the present invention producing irrelevant results. More specifically, the similarity factor functions as a filter for producing the most relevant results.

The display threshold is utilized to designate relevant entities from the plurality of buyable entities. More specifically, the present invention designates the relevant entities from the plurality of buyable entities if the similarity factor for each of the relevant entities exceeds the display threshold. Next, the present invention sorts the relevant entities by the similarity factor for each of the relevant entities. As an example, if the user account has priority on the price of a product or service from the plurality of buyable entities, the relevant entities are organized according to the price. In another instance if the user account has priority on the accessibility to a service, the relevant entities are organized according to the accessibility to the service. When sorting the relevant entities is complete, the present invention displays the sorted relevant entities to the user account through a user interface. However, only the relevant entities available for purchase at that instant of time are displayed. The user interface utilized to display the relevant entities can be, but is not limited to, a mobile phone or a computer.

The convenience of online shopping has resulted in many users utilizing online sales websites frequently. Due to the increasing demand, a plurality of frequently bought entities of the plurality of buyable entities remains available only for a limited time period. Therefore, if the user account has a preferred buyable entity of the plurality of buyable entities, but the preferred buyable entity is not available initially, the user account needs to repeat the search process until the preferred buyable entity is found. The present invention addresses the issue by eliminating the need to repeat the search process. In order to do so, the present invention tracks sales and availability of the plurality of buyable entities. Based on the tracked sales records and tracked availability records, the present invention initially updates the plurality of buyable entities with new buyable entities from the plurality of external sales websites. Simultaneously, the new buyable entities are organized in an appropriate manner. When updating the plurality of buyable entities with the new buyable entities is complete, the previously received search query is compared against the plurality of identifiers for each of the new buyable entities. The comparison is utilized to compute the similarity factor between the search query and each of the new buyable entities. Based on the comparison, new relevant entities are designated from the new buyable entities if the similarity factor of the new relevant entities exceeds the best match threshold. In particular, the best match threshold is a measure of discovering the preferred buyable entity from the new buyable entities. When the new buyable entities are designated, the present invention sends a notification to the user account for the new relevant entities through a line of communication. Therefore, it is guaranteed that the user account is notified as soon as the preferred buyable entity is available. In other words, the present invention functions on a first-come, first-served basis since the user account is notified immediately regarding the preferred buyable entity.

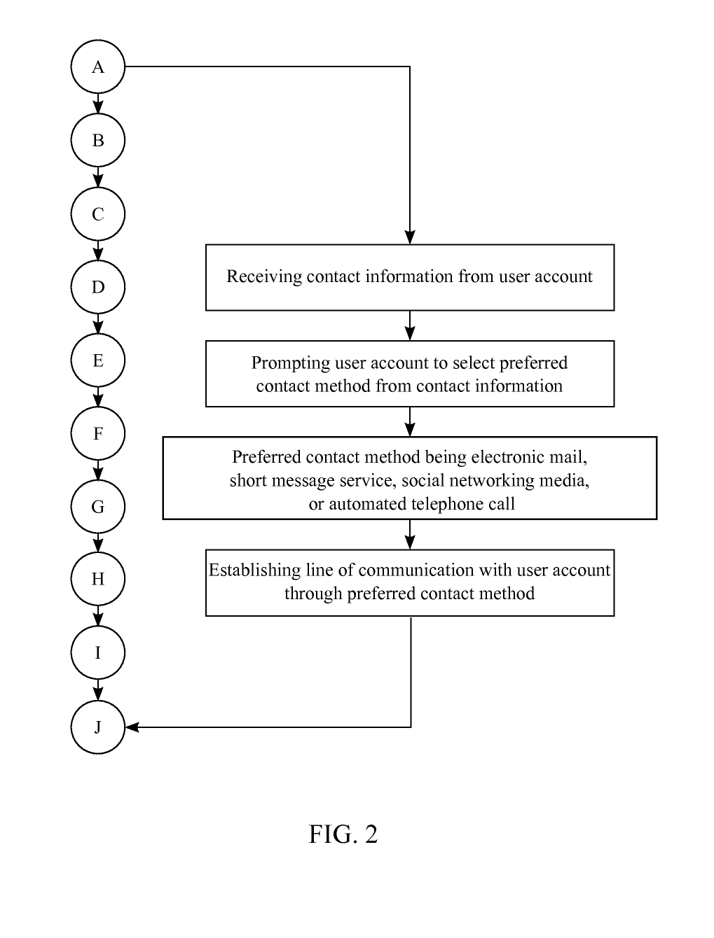

The present invention notifies the user account through contact information received when creating the user account. As illustrated in FIG. 2, the user provides multiple contact methods when creating the user account. However, the user account is prompted to select a preferred contact method from the contact information provided. The present invention utilizes the preferred contact method to establish the line of communication with the user account in order to notify the user account regarding the new buyable entities. The preferred contact method can vary from one user to another. As an example, the preferred contact method can be set to be an electronic mail. In such instances, the user account receives the notification regarding the new buyable items through the electronic mail. If the preferred contact method is a short message service, the present invention notifies the user account through the short message service associated with the mobile phone number provided by the user account. Social networking media can also be utilized as the preferred contact method. In such instances, a selected social networking media account notifies the user account regarding the new buyable entities. An automated telephone call can also be utilized to notify the user account as soon as the new buyable entities are available. In particular, the automated telephone call contacts the user account at the provided telephone number at a preferred time.

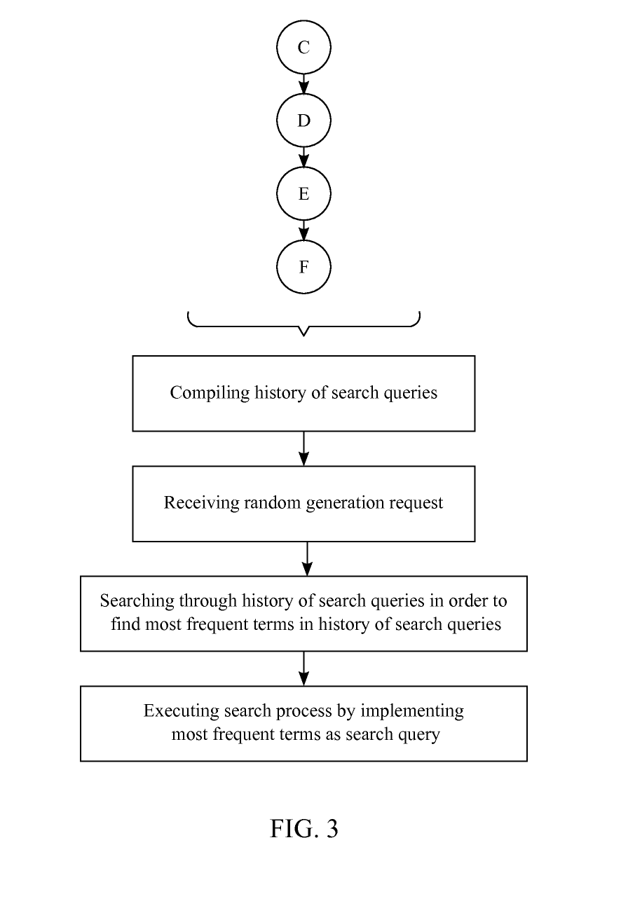

As illustrated in FIG. 3, the present invention provides the user account a quick search option through a random generation process. In order to complete the random generation process, the present invention compiles a history of search queries by reiterating the general overall process. The history of search queries is utilized to constantly update the relevant entities. When a random generation request is received from the user account, the present invention searches through the history of search queries in order to find most frequent terms in the history of search queries. Next, an iteration of the general overall process is executed by utilizing the most frequent terms as the search query. In the preferred embodiment of the present invention, the user account initiates the random generation request through a game. However, in other embodiments of the present invention, the random generation request can be initiated differently.

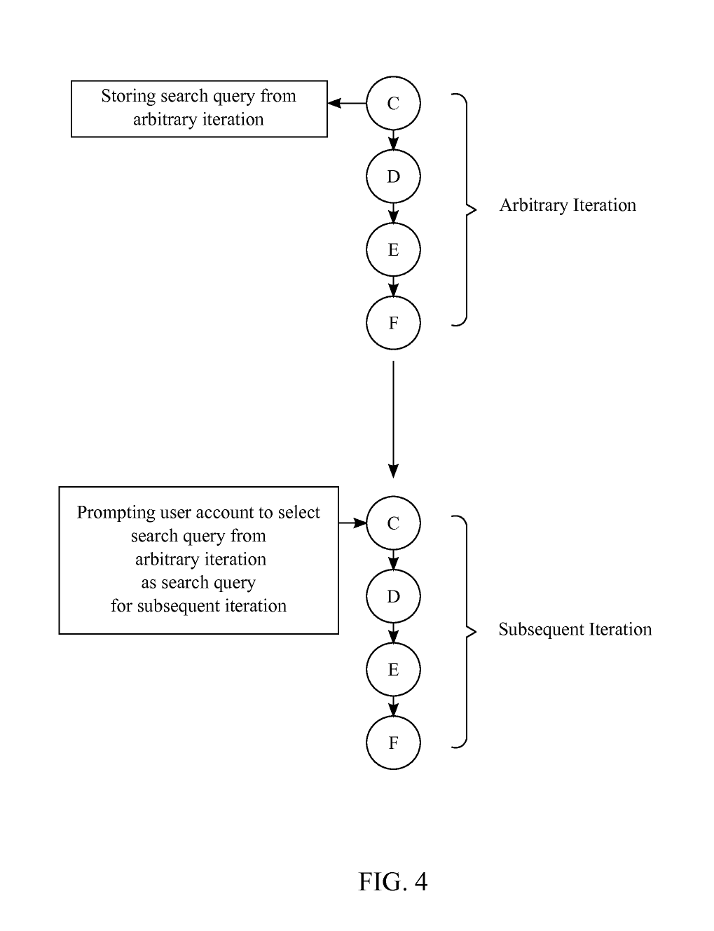

As discussed earlier, the present invention eliminates the need to reenter search queries. As illustrated in FIG. 4, when the general overall process is executed as an arbitrary iteration, the present invention stores the search query from the arbitrary iteration. Next, when the general overall process is executed as a subsequent iteration, the user account is prompted to select the search query from the arbitrary iteration as the search query of the subsequent iteration. Therefore, the need to reenter search queries from the previous search is eliminated.

When the present invention is utilized, the consequent process flow is followed. As an initial step, the user account is created. Simultaneously, the contact information for the user is received along with the preferred contact method. In order to cater the needs of the user account, the present invention retrieves the plurality of buyable entities from the plurality of external sales websites. Next, the present invention receives the search query from the user account. Subsequently, the general overall process illustrated in FIG. 1A and FIG. 1B is executed. As a result, the user account can proceed to purchase the preferred buyable entity or continue searching for the preferred buyable entity. If the preferred buyable entity is not available at that time, the present invention notifies the user account through the preferred contact method as soon as the preferred buyable entity is available. In another instance, when the user account decides to conduct a quick search, the present invention receives the random generation request. Afterwards, the general overall process is executed by using the most frequent terms as the search query. Since the present invention stores the search query from the arbitrary iteration, the user account can utilize the stored search query in the subsequent iteration when searching for the preferred buyable entity.

Although the invention has been explained in relation to its preferred embodiment, it is to be understood that many other possible modifications and variations can be made without departing from the spirit and scope of the invention as hereinafter claimed.

What is claimed is:

1. A method of managing listings for products and services from external sales websites by executing computer-executable instructions stored on a non-transitory computer-readable medium, the method comprises the steps of:
(A) providing a user account, a display threshold, and a best match threshold;
(B) retrieving a plurality of buyable entities from a plurality of external sales websites, wherein each of the plurality of buyable entities includes a plurality of identifiers;
(C) receiving a search query from the user account;
(D) comparing the search query against the plurality of identifiers for each of the plurality of buyable entities in order to compute a similarity factor between the search query and each of the plurality of buyable entities;
(E) designating relevant entities from the plurality of buyable entities, if the similarity factor for each of the relevant entities exceeds the display threshold;
(F) sorting and displaying the relevant entities by the similarity factor for each of the relevant entities to the user account;
(G) updating the plurality of buyable entities with new buyable entities from the plurality of external sales websites;
(H) comparing the search query against the plurality of identifiers for each of the new buyable entities in order to compute the similarity factor between the search query and each of the new buyable entities;
(I) designating new relevant entities from the new buyable entities, if the similarity factor for each of the new relevant entities exceeds the best match threshold; and
(J) sending a notification for the new relevant entities through a line of communication with the user account.

2. The method of managing listings for products and services from external sales websites by executing computer-executable instructions stored on a non-transitory computer-readable medium, the method as claimed in claim 1 further comprises the steps of:
receiving contact information from the user account;
prompting the user account to select a preferred contact method from the contact information; and
establishing the line of communication with the user account through the preferred contact method.

3. The method of managing listings for products and services from external sales websites by executing computer-executable instructions stored on a non-transitory computer-readable medium, the method as claimed in claim 2, wherein the preferred contact method is through electronic mail.

4. The method of managing listings for products and services from external sales websites by executing computer-executable instructions stored on a non-transitory computer-readable medium, the method as claimed in claim 2, wherein the preferred contact method is through short message service.

5. The method of managing listings for products and services from external sales websites by executing computer-executable instructions stored on a non-transitory computer-readable medium, the method as claimed in claim 2, wherein the preferred contact method is through social networking media.

6. The method of managing listings for products and services from external sales websites by executing computer-executable instructions stored on a non-transitory computer-readable medium, the method as claimed in claim 2, wherein the preferred contact method is through an automated telephone call.

7. The method of managing listings for products and services from external sales websites by executing computer-executable instructions stored on a non-transitory computer-readable medium, the method as claimed in claim 1 comprises the steps of:
compiling a history of search queries by reiterating steps (C) through (F);
receiving a random generation request;
searching through the history of search queries in order to find most frequent terms in the history of search queries; and
executing an iteration of steps (C) through (F) by implementing the most frequent terms as the search query.

8. The method of managing listings for products and services from external sales websites by executing computer-executable instructions stored on a non-transitory computer-readable medium, the method as claimed in claim 1 comprises the steps of:
executing steps (C) through (F) as an arbitrary iteration;
storing the search query from the arbitrary iteration;
executing steps (C) through (F) as a subsequent iteration; and
prompting the user account to select the search query from the arbitrary iteration as the search query of the subsequent iteration.
